(19) United States
(12) Patent Application Publication
(10) Pub. No.: US 2021/0111409 A1
(43) Pub. Date: Apr. 15, 2021

(54) LITHIUM SECONDARY BATTERY

(71) Applicants: Hyundai Motor Company, Seoul (KR); Kia Motors Corporation, Seoul (KR)

(72) Inventors: Kyo Min Shin, Hwaseong (KR); Yoon Ji Lee, Bucheon (KR); Yeayeon Lee, Seoul (KR); Sungmin Choi, Siheung (KR); Yeolmae Yeo, Hwaseong (KR); Dong Hui Kim, Suwon (KR)

(21) Appl. No.: 16/781,705

(22) Filed: Feb. 4, 2020

(30) Foreign Application Priority Data
Oct. 15, 2019 (KR) 10-2019-0127402

(51) Int. Cl. H01M 4/62; H01M 10/0525; H01M 10/0562; H01M 2/16; H01M 4/134; H01M 4/36; H01M 4/38; H01M 4/583

(52) U.S. Cl. CPC H01M 4/622; H01M 10/0525; H01M 10/0562; H01M 4/583; H01M 4/134; H01M 4/364; H01M 4/386; H01M 2/16

(57) ABSTRACT

Provided is a lithium secondary battery comprising: a cathode comprising a cathode active material; an anode comprising an anode active material composite; a separator positioned between the cathode and the anode; and an electrolyte, wherein the anode active material composite comprises: a core; a conductive composite film layer formed on a surface of the core and comprising a first conductive agent and a first binder; and a conductive layer formed on a surface of the conductive composite film layer and comprising a second conductive agent and a second binder.

### CROSS-REFERENCE TO RELATED APPLICATION

This application is based on and claims priority under 35 U.S.C. § 119 to Korean Patent Application No. 10-2019-0127402, filed on Oct. 15, 2019 in the Korean Intellectual Property Office, the disclosure of which is incorporated herein by reference.

### BACKGROUND

### 1. Field

The present disclosure relates to a lithium secondary battery, and more particularly, to an anode of a lithium secondary battery having improved output and lifespan characteristics, and a lithium secondary battery including the same.

### 2. Description of the Related Art

In general, lithium secondary batteries including an electroactive material have higher driving voltage and higher energy density compared to lead batteries or nickel/cadmium batteries. Accordingly, lithium secondary batteries have drawn attention as energy storage devices of electric vehicles (EVs) and hybrid electric vehicles (HEVs).

In order to improve the mileage of electric vehicles, high energy/long lifespan of lithium secondary batteries is the most important issue. To this end, the electrode density of high-capacity cathode and anode materials need to be increased or the thickness of the electrode need to be increased. However, in this case, the output of the secondary battery tends to be lowered, and it takes a long time to charge the high-capacity secondary battery. As such, it is not easy to satisfy both the high-power performance for fast charging and the high energy performance for improved mileage.

Silicon, which has a high specific capacity, is spotlighted as a material capable of improving the energy density of lithium secondary batteries. However, since the silicon anode has a large volume changes when react with lithium during charging and discharging, detachment (exfoliation from current collector) and cracking of the electrode are likely to occur. As a result, a path of electrons is disconnected or isolated, and the lifespan of the battery is drastically reduced or the safety is lowered.

In order to remove such limitations, technologies have been developed to suppress the volume change of silicon or to reduce the expansion of the electrode by forming composite silicon with carbon or graphite. In addition, technologies are being developed to apply fiber-type conductive agents such as carbon nanotubes (CNTs). However, there is a need to develop an anode having improved output and lifespan characteristics by improving dispersion of CNTs and preventing the durability degradation caused by the volume change of silicon.

### SUMMARY

In one aspect, we now provide a lithium secondary battery having improved output and lifespan characteristics.

In one aspect, a lithium secondary battery is provided that comprises: a cathode comprising a cathode active material; an anode comprising an anode active material composite; a separator positioned between the cathode and the anode; and an electrolyte, wherein the anode active material composite comprises: a core; a conductive composite film layer formed on a surface of the core and including a first conductive agent and a first binder; and a conductive layer formed on a surface of the conductive composite film layer and comprising a second conductive agent and a second binder. In one aspect, the first conductive agent is different (e.g. different chemical composition) than the second conductive agent, and the first binder may be the same or different (e.g. the same or different chemical composition) than the second binder. In another aspect, the first conductive agent is the same or substantially the same (e.g. the same or at least 80, 85, 90, 95 weight percent the same chemical composition) as the second conductive agent, and the first binder may be the same or different (e.g. the same or different chemical composition) than the second binder.

The core suitably may be provided using a primary particle including silicon or graphite.

The core also suitably may be provided using a secondary particle including a silicon-carbon composite particle.

Such particles that may be used to form the core in whole or part suitably may have a variety of dimensions such as an average particle diameter of from 2, 5, 01, 20 nm to 50, 40, 30, 20, 10, or 50 μm. For instance, in one preferred aspect, a silicon-carbon composite particle suitably may have an average particle diameter of about 10 nm to 10 μm.

The core also suitably may have a variety of dimensions. For instance, in one preferred aspect, the core suitably may have a diameter or longest dimension of about 50nm to 40 μm.

The first conductive agent may include at least one selected from the group consisting of carbon nanotubes (CNT), carbon nanofibers, and graphene.

A content of the first conductive agent may be 30 to 80% by weight based on the total weight of the first and second conductive agent.

The first binder suitably may include for example carboxymethyl cellulose (CMC), or an acrylic-based polymer as well as others.

The second binder suitably may be of a variety of forms and compositions including a chain polymer or a crosslinked polymer.

In one preferred aspect, the conductive layer suitably may be formed as a composite of a styrene-butadiene rubber (SBR) and the second binder. Other materials may be suitably used for the conductive layer including acrylate (including aryl acrylates) and novolak polymers together with the second binder.

The second binder may include at least one selected from the group consisting of polyacrylic acid (PAA), Li-PAA partially substituted with Li, a copolymer of PAA and Li-PAA, an acyl-based polymer having a functional group of an amine group or a carboxylic acid group, and a metacrylate-based polymer. Other materials also may be suitably used and preferred materials can be identified empirically.

The second conductive agent may include at least one selected from the group consisting of a fiber-type conductive agent, a dot-type conductive agent, and a mixture thereof.

A content of the second conductive agent suitably may be for example 20 to 70% by the total weight of the conductive agent.

The dot-type conductive agent may include for example at least one selected from the group consisting of carbon nanoparticles, carbon black, acetylene black, ketjen black, channel black, furnace black, lamp black, and summer black.

Other aspects of the invention are disclosed infra.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a schematic diagram illustrating an anode active material composite for a lithium secondary battery according to one embodiment of the present disclosure;

FIG. 2 is a schematic diagram illustrating an anode active material composite for a lithium secondary battery according to another embodiment of the present disclosure;

FIG. 3 is a schematic diagram illustrating an anode active material composite for a lithium secondary battery according to another embodiment of the present disclosure;

FIG. 4 is a schematic diagram illustrating an anode active material composite for a lithium secondary battery according to another embodiment of the present disclosure;

FIG. 5 is a schematic diagram illustrating an anode active material composite for a lithium secondary battery according to another embodiment of the present disclosure;

FIG. 6 is a SEM photograph illustrating an electrode using an anode active material composite for a lithium secondary battery according to the present disclosure; and

FIG. 7 is a graph showing discharge capacity according to the number of cycles of a lithium secondary battery according to one embodiment.

### DETAILED DESCRIPTION

Like numerals refer to like elements throughout the specification. Not all elements of embodiments of the present disclosure will be described, and description of what are commonly known in the art or what overlap each other in the embodiments will be omitted.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless the context clearly indicates otherwise.

As used herein, the singular forms “a,” “an” and “the” are intended to include the plural forms as well, unless the context clearly indicates otherwise.

Hereinafter, embodiments of the present disclosure will be described in detail with reference to the accompanying drawings and tables. First, lithium secondary batteries will be described, and then an anode according to the disclosed embodiments will be described in detail.

Lithium secondary batteries generally include a cathode, an anode, a separator, and an electrolyte. The separator, the electrolyte, and the cathode according to the present disclosure may be implemented using a separator, an electrolyte, and a cathode generally used in manufacturing the conventional lithium secondary batteries.

The separator is used to provide a path of lithium ions and physically separate the opposite electrodes from each other. Any separator commonly used in lithium secondary batteries may be used without limitation, particularly, any separator having a low resistance against migration of ions of the electrolyte and excellent electrolyte-retaining ability may be used.

For example, the separator may be any known porous polymer film. For example, a porous polymer film including a polyolefin-based polymer, such as an ethylene homopolymer, a propylene homopolymer, an ethylene/butene copolymer, an ethylene/hexene copolymer, or an ethylene/methacrylate copolymer, may be used alone or in a stacked structure.

In addition, a porous film coated with a highly stable resin may be used for the separator. When a solid electrolyte, such as a polymer, is used as the electrolyte, the solid electrolyte may also serve as a separator.

The electrolyte may i) lithium salt and ii) a non-aqueous organic solvent, and may further include additives for improving charge/discharge characteristics, preventing overcharge, and the like. Preferably, the lithium salt may suitably include one or more lithium salts selected from the group consisting of LiPF₆, LiBF₄, LiClO₄, LiCl, LiBr, Lil, LiB₁₀Cl₁₀, LiCF₃SO₃, LiCF₃CO₂, LiAsF₆, LiSbF₆, LiAICl₄, CH₃SO₃Li, CF₃SO₃Li, LiN(SO₂C₂F₅)₂, Li(CF₃SO₂)₂N, LiC₄FgSO₃, LiB(C₆H₅)₄, Li(SO₂F)₂N, LiFSl and (CF₃SO₂)₂NLi.

The non-aqueous organic solvent may suitably include one or more of carbonate, ester, ether and ketone. Examples of the carbonate may suitably include dimethyl carbonate (DMC), diethyl carbonate (DEC), dipropyl carbonate (DPC), methyl propyl carbonate (MPC), ethyl propyl carbonate (EPC), ethyl methyl carbonate (EMC), ethylene carbonate (EC), propylene carbonate (PC), butylene carbonate (BC), fluoroethylene carbonate (FEC), vinylene carbonate (VC) and the like. The ester may suitably include y-Butyrolactone (GBL), n-methyl acetate, n-ethyl acetate, n-propyl acetate and the like. The ether may suitably include dibutyl ether and the like.

The non-aqueous organic solvent may further include an aromatic hydrocarbon-based organic solvent. Examples of the aromatic hydrocarbon-based organic solvent may suitably include one or more benzene, fluorobenzene, bromobenzene, chlorobenzene, cyclohexylbenzene, isopropylbenzene, n-butylbenzene, octylbenzene, toluene, xylene, mesitylene, and the like.

An electrode may include an electrode active material. For instance, the electrode according to an embodiment may be formed by applying an electrode slurry having a mixture of an electrode active material, a conductive agent, a solvent, and a binder to an electrode current collector by a predetermined thickness, and then drying and rolling the electrode current collector having the electrode slurry applied thereto.

The electrode current collector is not particularly limited and may be provided using any electrode current collector generally used in lithium secondary batteries as long as it has high conductivity without causing chemical change in the lithium secondary battery. For example, the electrode current collector may be provided using stainless steel, aluminum, nickel, titanium, calcined carbon, or aluminum or stainless steel that is surface treated with carbon, nickel, titanium, silver or the like. Fine concavities and convexities may be formed on the surface of the electrode current collector to increase the adhesion of the cathode active material, and the electrode current collector may be provided in various forms, such as a film, a sheet, a foil, a net, a porous body, a foam, and a nonwoven fabric.

A cathode active material may include a compound that promote or induce reversible lithiation and delithiation reaction of lithiums. Preferably, the cathode active material may suitably include one or more of composite oxides including lithium and one or more metal selected from the group consisting of cobalt (Co), manganese (Mn), and nickel (Ni).

Hereinafter, the anode of the lithium secondary battery according to the disclosed embodiment will be described in detail.

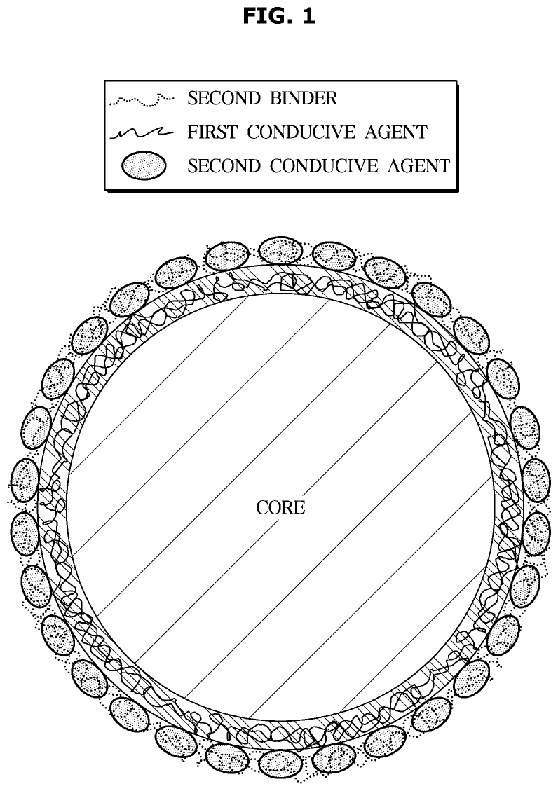

FIG. 1 is a schematic diagram illustrating an anode active material composite for a lithium secondary battery according to one embodiment of the present disclosure.

The anode according to the disclosed embodiment includes an anode active material composite including: a core; a conductive composite film layer formed on a surface of the core and including a first conductive agent and a first binder; and a conductive layer formed on a surface of the conductive composite film layer and including a second conductive agent and a second binder.

The core may be formed of any anode active material as long as it can lithiate (intercalate) or delithiate (deintercalate) lithium ions. The core may include one or more of a material capable of reversible lithation or delithiation of lithium and a material forming an alloy with lithium.

According to the disclosed embodiments, the core may include silicon having an energy density higher than that of graphite to increase the energy density. The core containing silicon conceptually includes silicon oxides, silicon particles, silicon alloy particles, and the like. Examples of the silicon alloy include a solid solution including aluminum (Al), manganese (Mn), iron (Fe), titanium (Ti), and the like with silicon, an intermetallic compound with silicon, and a eutectic alloy with silicon, but are not limited thereto.

However, silicon undergoes volume changes during a charge and discharge process. Silicon alloyed up to Li4.4Si during charging undergoes a volume expansion of about four times, which causes exfoliation of the active material layer from current collector o cracking of the electrode, and also causes disconnection or isolation of the electron path. The exfoliation and cracking of the electrode may deteriorate the safety of the electrode as well as the lifespan of the electrode.

In order to remove the above-described limitation, the disclosed embodiment provides a lithium secondary battery having an improved lifespan and output by introducing a conductive composite film layer and a conductive layer on the surface of the core, which is formed of an anode active material, to suppress the volume expansion of silicon such that the electrical path is secured and the electrical conductivity is improved.

In the lithium secondary battery according to the disclosed embodiment, the core of the anode active material composite may be provided using a primary particle including silicon or graphite.

In the lithium secondary battery according to the disclosed embodiment, the core of the anode active material composite may be provided using a secondary particle including a silicon-carbon composite.

The silicon-carbon composite may be formed by performing a thermal decomposition deposition process on a silicon source and a carbon source. The silicon-carbon composite includes silicon-carbon covalent bonds, silicon-silicon covalent bonds, and carbon-carbon covalent bonds, and the covalent bonds may be irregularly present in the silicon-carbon composite.

The carbon-based material is not particularly limited as long as it has excellent electrical conductivity without causing side reactions in the internal environment of the lithium secondary battery and chemical changes to the battery. The carbon-based material may include amorphous carbon and crystalline carbon, such as natural graphite with a high degree of graphitization, artificial graphite, carbon black, meso carbon microbead (MCMB), carbon fiber, and the like. Of these, the graphite-based materials, such as artificial graphite or natural graphite, are preferred.

In this case, the content of silicon in the silicon-carbon composite suitably may be 3 to 97% by weight. If the silicon content is less than 3%, it is difficult to develop a high-capacity battery and the mileage of the vehicle battery may not be increased. On the contrary, if the silicon content is greater than 97%, the mileage may be improved by implementing a high capacity of the vehicle battery, but the lifespan characteristics of the battery may be reduced due to the volume expansion of the silicon-carbon composite.

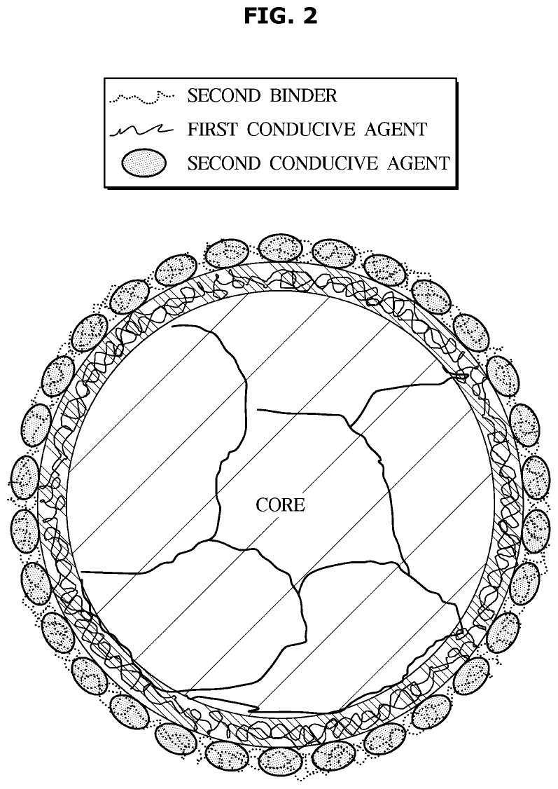

FIG. 2 is a schematic diagram illustrating an anode active material composite for a lithium secondary battery according to another embodiment of the present disclosure.

Referring to FIG. 2, the core may be provided in the form of the secondary particle formed by agglomeration of silicon-carbon composite particles having an average particle size of 10 nm to 10 μm.

On the other hand, the average particle diameter of the core having the secondary particle form may be 50 nm to 40 μm, preferably, 100nm to 20 μm. If the diameter of the core is less than 50 nm, not only the density of the core is significantly lowered but also the electrode is difficult to be manufactured, and if the diameter of the core is greater than 40 μm, the electrode may be thick and the movement distance of lithium ions may be long, and in addition, the electrical conductivity of the core is greatly reduced, thereby deteriorating the characteristics of the lifespan and the rate capability of the lithium secondary battery.

Referring to FIGS. 1 and 2, the conductive composite film layer may be formed by coating a conductive material on the surface of the core. Specifically, the anode active material composite according to fthe disclosed embodiment is characterized in that the conductive composite film layer is formed on the core surface, and the conductive composite film layer includes the first conductive agent and the first binder.

Since a silicon-based anode active material or silicon-carbon composite anode active material alone may lack conductivity, a conductive material including a conductive agent is coated on or coupled to all or part of the core surface, so that the electrical conductivity may be improved.

According to the disclosed embodiment, the first conductive agent may include at least one selected from the group consisting of carbon nanotubes (CNT), carbon nanofibers, and graphene.

The carbon nanotubes and carbon nanofibers are materials having a strength 100 times greater than that of steel and the highest thermal conductivity in nature comparable to diamonds. The carbon nanotubes and carbon nanofibers have an energy density 5 times greater than that of carbon black, which is generally used as a conductive agent, and have an electric conductivity higher than that of carbon block by 10%, so that the charging time of the lithium secondary battery may be reduced.

On the other hand, when silicon is used as the anode material, the silicon causes swelling of the battery due to lack of conductivity, which lowers the battery safety. In this case, by using conductive agents, such as carbon nanotubes and carbon nanofibers having a higher conductivity compared to carbon black, battery swelling is prevented and the battery safety is improved.

In addition, the graphene has a surface area of about 2600 m²/g, and an electron mobility of 15,000 to 200,000 cm²/Vs, exhibiting highly useful properties compared to other carbon materials. In particular, the rate of electron transport in graphene is almost close to the velocity of light because electrons flow in graphene as if massless. The graphene may be generally manufactured by a scotch tape method, an epitaxy method using a silicon carbide insulator, a chemical method using a reducing agent, and a method using a metal catalyst.

The content of the first conductive agent may be 30 to 80% by weight on the total weight of the first and second conductive agent. When the content of the first conductive agent is less than 30% by weight, the effect of the conductive agent is insignificant to increase the resistance. When the content of the conductive agent is greater than 80% by weight, the electrical conductivity between the active materials formed by introduction of the second conductive agent, which will be described below, is insufficient to cause isolation of electrical network or increase of resistance by the second binder to be described below, thereby degrading the lifetime and output characteristics.

In addition, in the anode active material composite according to the embodiment of the present disclosure, the conductive composite film layer may be derived from the first binder (an organic polymer component, not shown). Specifically, the conductive composite film layer may be formed by heat treatment of the first binder. In the absence of the first binder, the conductive agent is difficult to be agglomerated or exist on the surface of the core.

The first binder is not particularly limited as long as it is a resin serving as a matrix, and specifically, may be provided as a polymer resin generally used in secondary battery binder materials, and including carboxymethyl cellulose (CMC) or an acrylic polymer.

That is, in the anode active material composite of the present disclosure, the conductive composite film layer may have a structure in which a matrix is formed and the first conductive agent is included as a filler in the matrix. The first conductive agent included in the conductive composite film layer is graphene or a linear conductive agent and is characterized by being located on the core surface. The first conductive agent may be dispersed on the surface of the core by the first binder.

Referring to FIGS. 1 and 2, the conductive layer may be formed on the surface of the conductive composite film layer. The conductive layer may be provided using a second conductive agent including at least one selected from the group consisting of a fiber-type conductive agent, a dot-type conductive agent, and a mixture thereof.

The fiber-type conductive agent may be provided using carbon nanotubes (CNT) or carbon nanofibers. Description thereof will be omitted.

The dot-type conductive agent may include at least one selected from the group consisting of carbon nanoparticles, carbon black, acetylene black, ketjen black, channel black, furnace black, lamp black, and summer black.

On the other hand, the conductive layer may be formed in a mixture of the fiber-type conductive agent and the dot-type conductive agent.

The content of the second conductive agent may be 20 to 70% by weight based on the total weight of the first and second conductive agent. When the content of the second conductive agent is less than 20% by weight, the electrical conductivity between active materials is insufficient, so that the effect of the conductive agent may be insignificant due to the isolation of the electrical network or the increase of the resistance by the binder. When the content of the second conductive agent is greater than 70% by weight, the effect of the conductive layer is lowered, making it difficult to increase the electrical conductivity of the core.

The conductive layer may be formed on the conductive composite film layer while forming an interface with the conductive composite film or partially being composited with the conductive composite film.

The conductive layer includes the second binder. The second binder may include foe example a chain-type polymer or a crosslinked polymer.

In the present disclosure, in preferred aspects, the chain-type polymer or crosslinked polymer binder serves to bond the silicon and the carbon and bond the active materials while holding silicon in place in the process of shrinking after expansion of the silicon. Preferably, the crosslinked polymer may more firmly hold the silicon in place in the process of shrinking after expansion of the silicon.

For example, the second binder may include at least one selected from the group consisting of polyacrylic acid (PAA), Li-PAA partially substituted with Li, a copolymer of PAA and Li-PAA, an acyl-based polymer having a functional group of an amine group or a carboxylic acid group, and metacrylate-based polymer.

In addition, the conductive layer may be provided as a composite of a styrene-butadiene rubber (SBR) and the second binder.

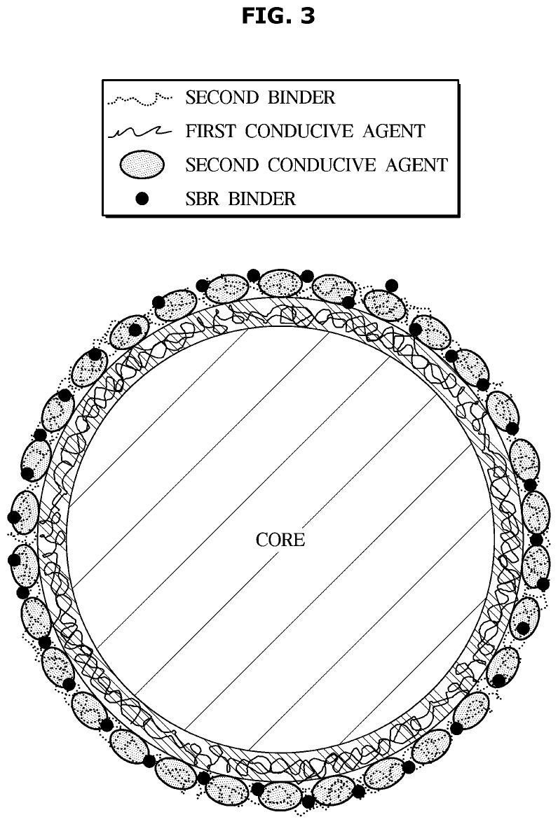

FIG. 3 is a schematic diagram illustrating an anode active material composite for a lithium secondary battery according to another embodiment of the present disclosure.

Referring to FIG. 3, it can be seen that the conductive layer is formed as a composite of styrene-butadiene rubber (SBR) and the second binder.

The conductive layer may be formed on the conductive composite film layer while forming an interface with the conductive composite film or partially being composited with the conductive composite film. SBR is an aqueous binder, and performs an adhesion function on the surface of the conductive composite film layer, and improve adhesion of a second conductive material-an active material and an active material-an active material.

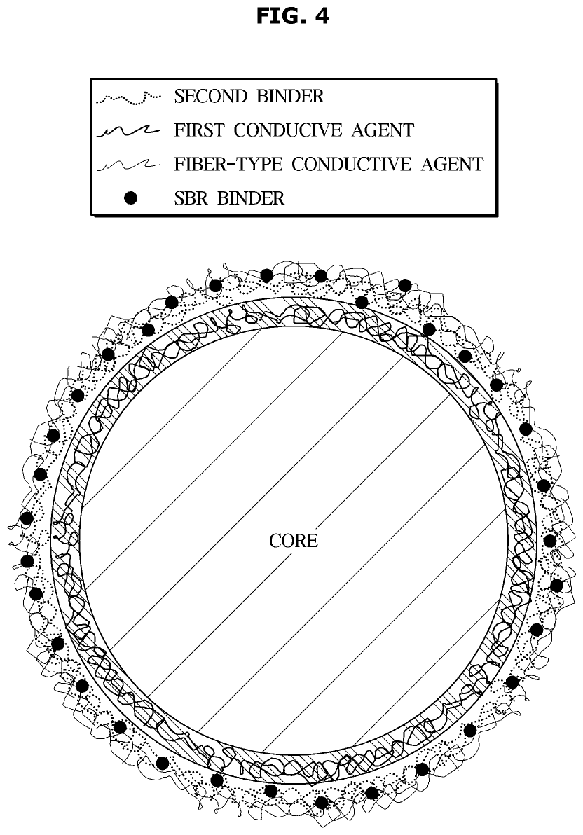

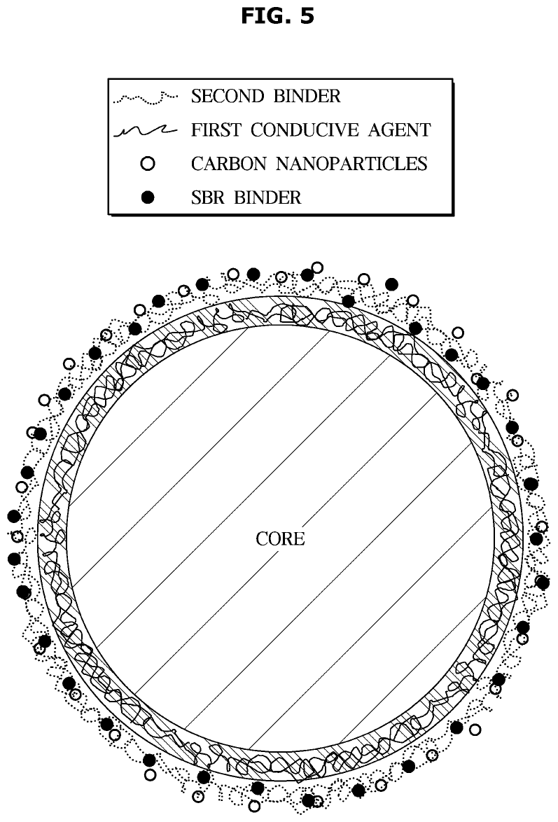

FIGS. 4 and 5 are schematic diagrams illustrating an anode active material composite for a lithium secondary battery according to other embodiments of the present disclosure.

Referring to FIGS. 4 and 5, in the anode active material composite according to the disclosed embodiment, the conductive layer may be provided on the surface of the conductive composite film layer in the form of a composite of the fiber-type conductive agent, the second binder, and the SBR binder, or a composite of the carbon nanoparticles (dot-type conductive agent), the second binder, and the SBR binder.

In addition, the anode active material composite may have the conductive layer in the form of a mixture of a fiber-type conductive agent and a dot-type conductive agent.

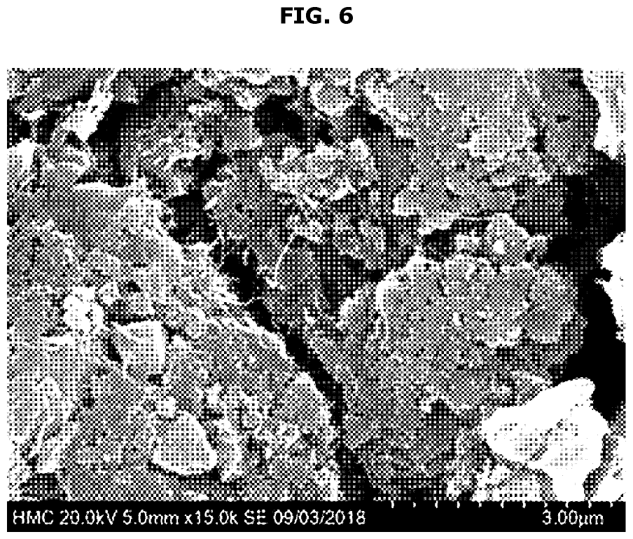

FIG. 6 is a SEM photograph illustrating an electrode using an anode active material composite for a lithium secondary battery according to the present disclosure.

Referring to FIG. 6, it can be seen that the conductive composite film layer and the conductive layer are formed on the surface of the core. As the secondary conductive layer is formed on the surface of the core and between the active materials, the conductivity of the electrode is improved.

Hereinafter, the output and lifespan characteristics of the lithium secondary battery according to the embodiment of the present disclosure will be described through exemplary embodiments and comparative examples. However, the following exemplary embodiments and comparative examples are only provided to aid in the explanation and understanding of the present disclosure and are not intended to limit the scope and spirit of the present disclosure.

0.1 g of carbon nanotube was used as the first conductive agent, 4.5 g of carboxymethyl cellulose was used as the first binder, and 10 g of silicon-carbon composite was used as the anode active material. The carbon nanotubes, the carboxymethyl cellulose, and the silicon-carbon composite were mixed with water to prepare a mixed solution. Subsequently, the mixed solution was sprayed and dried under conditions of an inlet temperature of 200 to 250° C., an outlet temperature of 60 to 80° C., and a speed of 15 to 25 cc/min in a drying chamber of spray drying equipment, and then is heat treated at 700° C., to thereby manufacture an anode active material composite in which a conductive composite film layer derived from carbon nanotubes and carboxymethyl cellulose is coated on the surface of a silicon-carbon composite.

Subsequently, 4.5 g of polyacrylic acid (PAA) forming a second binder was mixed with 0.1 g of carbon nanotubes forming a second conductive agent to form a conductive layer, and then the conductive layer is coated, dried, and pressed on both sides of a copper foil, to thereby prepare an anode. (Exemplary Embodiment 1).

Meanwhile, 0.1 g of carbon nanotubes forming a second conductive agent was mixed and 4.5 g of polyacrylic acid (PAA) and 4.5 g of styrene butadiene rubber forming a second binder was introduced to form a conductive layer, and then the conductive layer was coated, dried, and pressed on both sides of a copper foil, to thereby prepare an anode (Exemplary Embodiment 2).

Next, Li (Ni0.6Co0.2Mn0.2) O2 forming a cathode active material, polyvinylidene fluoride (PVdF) forming a binder, and carbon forming a conductive agent were mixed in a weight ratio of 93:4:3, and the mixture was dispersed in N-methyl-2-pyrrolidone to prepare a cathode slurry, and the cathode slurry was coated, dried, and pressed on an aluminum foil, to thereby prepare a cathode. A ceramic coated polyolefin-based separator was interposed between the prepared anode and cathode to form an electrode assembly, and an electrolyte solution was injected to prepare a pouch-type lithium secondary battery.

Lithium secondary batteries according to the comparative examples were manufactured in the same method as in the exemplary embodiment except for a conductive layer formed only using a second conducive agent (Comparative Example 1) and a conductive layer formed only using a second binder (Comparative Example 2) while omitting the conductive composite film layer on the surface of the core in each of Comparative Embodiments 1 and 2, and the electrode mix layer resistance and the electrode interface resistance of the lithium secondary battery were measured and shown in Table 1 below.

At a temperature of 45° C., a voltage of 2.5 to 4.2 V, and the charge/discharge rate of 0.5C, the lifespan characteristics of the lithium secondary batteries according to the exemplary embodiments and the comparative examples were evaluated, and the evaluation results are shown in Table 1.

When a battery discharges the total energy thereof in one hour, the discharge rate is defined as 1C (C-rate) discharge. That is, 2C refers to discharging the total capacity in 30 minutes, C/5 refers to discharge for 5 hours.

The capacity retention rate related to the lifetime characteristics was calculated as follows.

Capacity retention rate at the 100th cycle=discharge capacity at the 100th cycle/discharge capacity at the first cycle

TABLE 1

| | Exemplary | Exemplary | | |
|---|---|---|---|---|
| | embodiment | embodiment | Comparative | Comparative |
| | 1 | 2 | example 1 | example 2 |
| Electrode mix | 5.62 | 8.24 | 6.97 | 12.02 |
| layer resistance | | | | |
| (10⁻² Ωcm) | | | | |
| Electrode | 2.56 | 3.56 | 2.99 | 11.21 |
| interface | | | | |
| resistance | | | | |
| (10⁻³ cm2) | | | | |

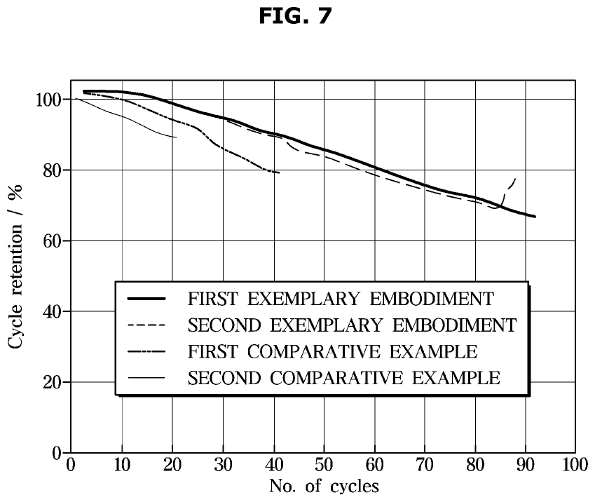

FIG. 7 is a graph showing the discharge capacity according to the number of cycles of a lithium secondary battery according an embodiment. In the exemplary embodiments and the comparative examples shown in FIG. 7, a lower slope of discharge capacity represents a smaller change in discharge capacity according to the number of charge/discharge cycles, which indicates excellent lifespan characteristics.

Referring to Table 1, it can be seen that Exemplary Embodiments 1 and 2 having the conductive composite film layer exhibit excellent durability and electrical conductivity. In addition, as shown in Table 1, compared to the lithium secondary batteries according to Comparative Examples 1 and 2, the lithium secondary battery according to the Exemplary Embodiments 1 and 2 maintain a capacity more than 70% of the initial capacity even after 80 cycles, which indicates excellent discharge capacity retention rate.

Comparative Example 1 in which the conductive layer was formed by introducing only the second conductive agent without the conductive composite film layer, the electrode mixture layer resistance and the electrode interface resistance were measured to be low, indicating excellent electrical conductivity, but the lifespan characteristics were evaluated only about 40 cycles.

In the case of Comparative Example 2 in which the conductive layer was formed by introducing only the second binder without the conductive composite film layer, it can be seen that the electrical resistance was high and the durability was the most inferior. It is considered that the deterioration of the durability of the lithium secondary battery was caused by the resistance effect of the second binder.

In conclusion, the anode active material composite according to the disclosed embodiment introduces the conductive composite film layer and the conductive layer on the surface of the core, which is the anode active material, to ensure dispersibility of the conductive agent, and also suppress the volume expansion of the silicon, thereby securing the electrical path, and improving the electrical conductivity, so that the lifespan and output characteristics of the lithium secondary battery may be improved at the same time.

Accordingly, the lithium secondary battery including the anode active material composite according to the disclosed embodiment is applicable to a medium-large battery for vehicles requiring high power and long lifespan.

As is apparent from the above, an anode of a lithium secondary battery adopts an anode active material having a conducive composite film layer and a conductive layer, so that durability deterioration due to volume expansion of silicon is suppressed while ensuring excellent output and lifespan characteristics compared to the conventional silicon anode, thereby developing a high energy density lithium secondary battery.

Although embodiments of the disclosure have been described with reference to the accompanying drawings, a person having ordinary skilled in the art will appreciate that other specific modifications can be easily made without departing from the technical spirit or essential features of the disclosure. Therefore, the foregoing embodiments should be regarded as illustrative rather than limiting in all aspects.

What is claimed is:

1. A lithium secondary battery comprising:
a cathode comprising a cathode active material;
an anode comprising an anode active material composite;
a separator positioned between the cathode and the anode; and
an electrolyte,
wherein the anode active material composite comprises:
a core;
a conductive composite film layer formed on a surface of the core and including a first conductive agent and a first binder; and
a conductive layer formed on a surface of the conductive composite film layer and including a second conductive agent and a second binder.

2. The lithium secondary battery of claim 1, wherein the core comprises a primary particle comprising silicon and/or graphite.

3. The lithium secondary battery of claim 1, wherein the core is comprises a secondary particle comprising a silicon-carbon composite particle.

4. The lithium secondary battery of claim 3, wherein the silicon-carbon composite particle has an average particle diameter of about 10 nm to 10 μm.

5. The lithium secondary battery of claim 4, wherein the core has a diameter of about 50 nm to 40 μm.

6. The lithium secondary battery of claim 1, wherein the first conductive agent comprises at least one selected from the group consisting of carbon nanotubes (CNT), carbon nanofibers, and graphene.

7. The lithium secondary battery of claim 1, wherein a content of the first conductive agent is 30 to 80% by weight based on the total weight of the first and second conductive agent.

8. The lithium secondary battery of claim 1, wherein the first binder comprises carboxymethyl cellulose (CMC), or an acrylic-based polymer.

9. The lithium secondary battery of claim 1, wherein the second binder comprises a chain polymer or a crosslinked polymer.

10. The lithium secondary battery of claim 1, wherein the conductive layer comprises a composite of a styrene-butadiene rubber (SBR) and the second binder.

11. The lithium secondary battery of claim 1, wherein the second binder includes at least one selected from the group consisting of polyacrylic acid (PAA), Li-PAA partially substituted with Li, a copolymer of PAA and Li-PAA, an acyl-based polymer having a functional group of an amine group or a carboxylic acid group, and a metacrylate-based polymer.

12. The lithium secondary battery of claim 1, wherein the second conductive agent comprises at least one selected from the group consisting of a fiber-type conductive agent, a dot-type conductive agent, and a mixture thereof.

13. The lithium secondary battery of claim 1, wherein a content of the second conductive agent is 20 to 70% by weight based on the total weight of the first and second conductive agent.

14. The lithium secondary battery of claim 12, wherein the dot-type conductive agent comprises at least one selected from the group consisting of carbon nanoparticles, carbon black, acetylene black, ketjen black, channel black, furnace black, lamp black, and summer black.

15. A vehicle comprising a battery of claim 1.
